(19) United States
(12) Patent Application Publication
(10) Pub. No.: US 2026/0270654 A1
(43) Pub. Date: Sep. 10, 2026

(54) DEVICES AND METHODS FOR COMMUNICATION

(71) Applicant: NEC Corporation, Tokyo (JP)

(72) Inventors: Wei CHEN, Beijing (CN); Gang WANG, Beijing (CN)

(73) Assignee: NEC Corporation, Tokyo (JP)

(21) Appl. No.: 19/471,416

(22) PCT Filed: Apr. 6, 2023
(86) PCT No.: PCT/CN2023/086736

§ 371 Date: Oct. 1, 2025

(51) Int. Cl. H04W 4/029

(52) U.S. Cl. CPC H04W 4/029

(57) ABSTRACT

Embodiments of the present disclosure provide a solution for ground-truth data collection for model monitoring. In the solution, a first communication device receives, from a second communication device, a model trigger condition indication or a model description related to an artificial intelligence/machine learning (AI/ML) model. The model trigger condition indication indicates a trigger condition for triggering the AI/ML model to be applied in direct positioning or assisted positioning of a terminal device. The model description comprising attribute information for ground-truth collection. The first communication device determines a target ground-truth collection mode for the AI/ML model based on the model trigger condition indication or the model description; and collects, based on the target ground-truth collection mode, ground-truth data for monitoring the AI/ML model.

### FIELDS

Example embodiments of the present disclosure generally relate to the field of communication techniques and in particular, to devices and methods for ground-truth data collection for model monitoring.

### BACKGROUND

In the telecommunication industry, artificial intelligence/machine learning (AI/ML) models have been employed in telecommunication systems to improve the performance of telecommunications systems. For example, supporting various positioning mechanisms to provide reliable and accurate locations of terminal devices has always been one of the key features of the telecommunications systems. It has been agreed to investigate the potential for AI/ML models in air interface to improve comprehensive performances in the telecommunication systems. AI/ML based positioning mechanism to improve the positioning accuracy is one of the use cases to apply AI/ML in air interface.

### SUMMARY

In general, embodiments of the present disclosure provide methods, devices and computer storage medium for ground-truth data collection for model monitoring.

In a first aspect, there is provided a first communication device. The first communication device comprises a processor configured to cause the first communication device to: receive, from a second communication device, a model trigger condition indication or a model description related to an artificial intelligence/machine learning (AI/ML) model, the model trigger condition indication indicating a trigger condition for triggering the AI/ML model to be applied in direct positioning or assisted positioning of a terminal device, and the model description comprising attribute information for ground-truth collection; and determine a target ground-truth collection mode for the AI/ML model based on the model trigger condition indication or the model description; and collect, based on the target ground-truth collection mode, ground-truth data for monitoring the AI/ML model.

In a second aspect, there is provided a second communication device. The second communication device comprises a processor configured to cause the second communication device to: transmit, to a first communication device, a model trigger condition indication or a model description related to an artificial intelligence/machine learning (AI/ML) model, the model trigger condition indication indicating a trigger condition for triggering the AI/ML model to be applied in direct positioning or assisted positioning of a terminal device, and the model description comprising attribute information for ground-truth collection, wherein the first communication device is configured for monitoring the AI/ML model, and a target ground-truth collection mode for collecting ground-truth data of the AI/ML model is determined based on the model trigger condition indication or the model description.

In a third aspect, there is provided a communication method. The method comprises: receiving, by a first communication device and from a second communication device, a model trigger condition indication or a model description related to an artificial intelligence/machine learning (AI/ML) model, the model trigger condition indication indicating a trigger condition for triggering the AI/ML model to be applied in direct positioning or assisted positioning of a terminal device, and the model description comprising attribute information for ground-truth collection; determining a target ground-truth collection mode for the AI/ML model based on the model trigger condition indication or the model description; and collecting, based on the target ground-truth collection mode, ground-truth data for monitoring the AI/ML model.

In a fourth aspect, there is provided a communication method. The method comprises: transmitting, by a second communication device and to a first communication device, a model trigger condition indication or a model description related to an artificial intelligence/machine learning (AI/ML) model, the model trigger condition indication indicating a trigger condition for triggering the AI/ML model to be applied in direct positioning or assisted positioning of a terminal device, and the model description comprising attribute information for ground-truth collection, wherein the first communication device is configured for monitoring the AI/ML model, and a target ground-truth collection mode for collecting ground-truth data of the AI/ML model is determined based on the model trigger condition indication or the model description.

In a fifth aspect, there is provided a computer readable medium having instructions stored thereon, the instructions, when executed on at least one processor, causing the at least one processor to carry out the method according to the third or fourth aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1A illustrates an example communication environment in which example embodiments of the present disclosure can be implemented;

FIG. 1B illustrates a signaling flow for a positioning procedure of a terminal device;

FIG. 2 illustrates a signaling flow for model monitoring in accordance with some embodiments of the present disclosure;

FIG. 3A illustrates an example workflow for AI/ML based positioning inference and verification in accordance with some embodiments of the present disclosure;

FIG. 3B illustrates an example of triangulation-based positioning to be applied for ground-truth data collection in accordance with some embodiments of the present disclosure;

FIG. 4A and FIG. 4B illustrate example formats of model trigger condition indication in accordance with some embodiments of the present disclosure;

FIG. 5A and FIG. 5B illustrate example model monitoring occasion patterns in accordance with some embodiments of the present disclosure;

FIG. 6 illustrates a signaling flow of an example positioning procedure with the AI/ML model at the network device side in accordance with some embodiments of the present disclosure;

FIG. 7 illustrates a signaling flow of an example positioning procedure with the AI/ML model at the LMF side in accordance with some further embodiments of the present disclosure;

FIG. 8 illustrates a flowchart of a method implemented at a first communication device according to some example embodiments of the present disclosure;

FIG. 9 illustrates a flowchart of a method implemented at a second communication device according to some example embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, devices on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g., FR1 (e.g., 450 MHz to 6000 MHz), FR2 (e.g., 24.25 GHz to 52.6 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, channel emulator. In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device. In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As used herein, the term “resource,” “transmission resource,” “uplink resource,” or “downlink resource” may refer to any resource for performing a communication, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “model” is referred to as an association between an input and an output learned from training data, and thus a corresponding output may be generated for a given input after the training. The generation of the model may be based on a machine learning technique. The machine learning techniques may also be referred to as artificial intelligence (AI) techniques. In general, a machine learning model can be built, which receives input information and makes predictions based on the input information. For example, a classification model may predict a class of the input information among a predetermined set of classes. As used herein, “model” may also be referred to as “machine learning model”, “learning model”, “machine learning network”, or “learning network,” which are used interchangeably herein.

Generally, machine learning may usually involve three stages, i.e., a training stage, a validation stage, and an application stage (also referred to as an inference stage). At the training stage, a given machine learning model may be trained (or optimized) iteratively using a great amount of training data until the model can obtain, from the training data, consistent inference similar to those that human intelligence can make. During the training, a set of parameter values of the model is iteratively updated until a training objective is reached. Through the training process, the machine learning model may be regarded as being capable of learning the association between the input and the output (also referred to an input-output mapping) from the training data. At the validation stage, a validation input is applied to the trained machine learning model to test whether the model can provide a correct output, so as to determine the performance of the model. Generally, the validation stage may be considered as a step in a training process, or sometimes may be omitted. At the application stage, the resulting machine learning model may be used to process a real-world model input based on the set of parameter values obtained from the training process and to determine the corresponding model output.

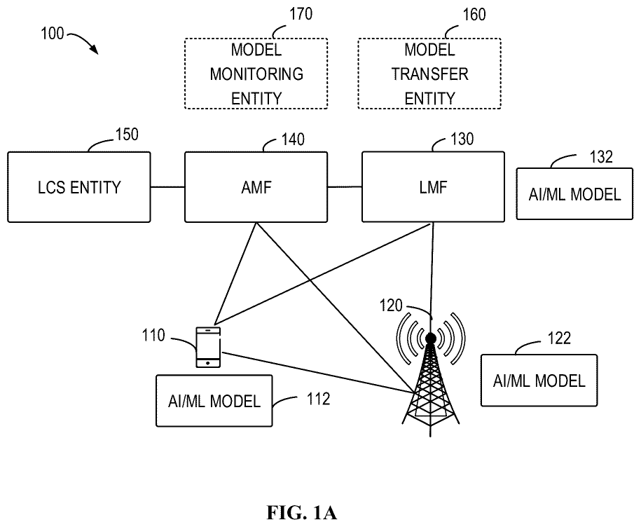

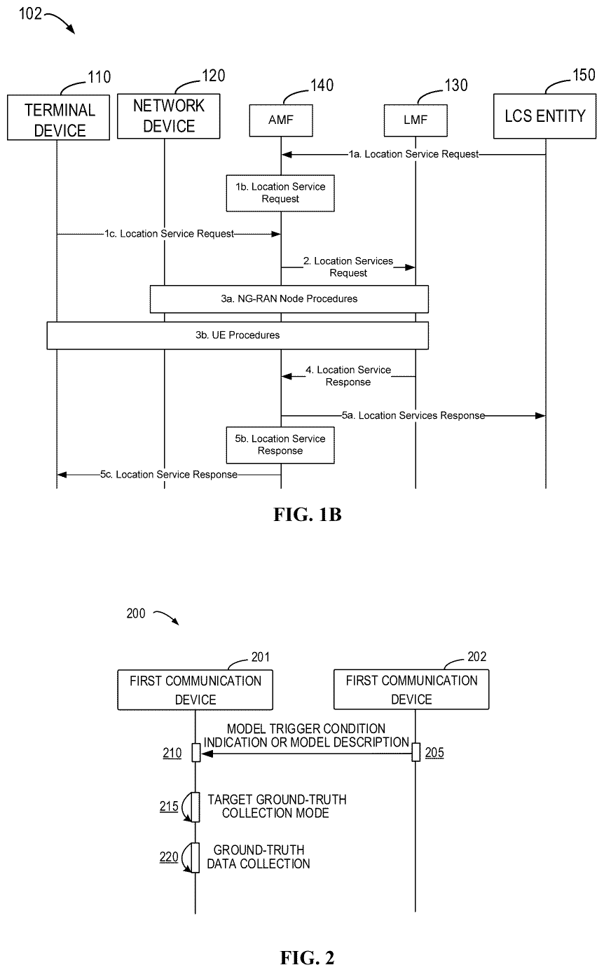

FIG. 1A illustrates a schematic diagram of an example communication environment 100 in which example embodiments of the present disclosure can be implemented. In the communication environment 100, a plurality of communication devices, including a terminal device 110, a network device 120, and a core network function such as a location management function (LMF) 130 and an access and mobility management function (AMF) 140 can communicate with each other. In some embodiments, there may be one or more location service (LCS) entities 150 which may communicate with the AMF 140 to request for location services.

The communications in the communication environment 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In the communication environment 100, the network device 120 may be a base station serving the terminal device 110. The serving area of the network device 120 may be called a cell (not shown). In the communication environment 100, the network device 120 and the terminal device 110 may communicate data and control information to each other.

It is to be understood that the number of devices and their connections shown in FIG. 1A are only for the purpose of illustration without suggesting any limitation. The communication environment 100 may include any suitable number of devices configured to implementing example embodiments of the present disclosure. Although not shown, it would be appreciated that one or more additional devices may be located in the cell, and one or more additional cells may be deployed in the communication environment 100. It is noted that although illustrated as a network device, the network device 120 may be another device than a network device. Although illustrated as a terminal device, the terminal device 110 may be other device than a terminal device, such as a positioning reference unit (PRU).

It is been specified positioning operations for determining of the terminal device 110. FIG. 1B illustrates a signaling flow 102 for a positioning procedure of a terminal device 110.

In operation, the positioning of the terminal device 110 is triggered for various reasons. For example, some LCS entity 150 in the core network (e.g. Gateway Mobile Location Centre, GMLC) requests (la) some location service (e.g. positioning) for a terminal device 110 to the serving AMF 140. Alternatively, the serving AMF 140 for the terminal device 110 determines (1b) the need for some location service (e.g., to locate the terminal device 110 for an emergency call). Alternatively, the terminal device 110 requests (1c) some location service (e.g. positioning or delivery of assistance data) to the serving AMF 140 at the non-access stratum (NAS) level.

The AMF 140 transfers (2) the location service request to an LMF 130. The LMF 130 instigates (3a) location procedures with the serving and possibly neighbouring new generation (NG) RAN network nodes, e.g., the network device 120, e.g., to obtain positioning measurements or assistance data. In addition to step 3a or instead of step 3a, the LMF 130 instigates (3b) location procedures with the terminal device 110, e.g., to obtain a location estimate or positioning measurements or to transfer location assistance data to the terminal device 110.

The LMF 130 provides (4) a location service response to the AMF 140 and includes any needed results, e.g., success or failure indication and, if requested and obtained, a location estimate for the terminal device 110.

If step 1a was performed, the AMF 140 returns (5a) a location service response to the 5GC entity in step 1a and includes any needed results—e.g. a location estimate for the terminal device 110. If step 1b occurred, the AMF 140 uses (5b) the location service response received in step 4 to assist the service that triggered this in step 1b (e.g. may provide a location estimate associated with an emergency call to a GMLC). If step 1c was performed, the AMF 140 returns (5C) a location service response to the terminal device 110 and includes any needed results—e.g. a location estimate for the terminal device 110.

Currently, it is now proposed to provide AI/ML based positioning of terminal devices. An AI/ML model may be trained to implement direct positioning or assisted positioning of terminal devices. In some embodiments, such AI/ML models may be deployed at the terminal device 110, the network device 120, and/or the LMF 130, or both of them. As illustrated, an AI/ML model 112 may be deployed at the terminal device 110, for direct positioning or assisted positioning of the terminal device 110. Alternatively, or in addition, an AI/ML model 122 may be deployed at the network device 120, for direct positioning or assisted positioning of the terminal device 110. Alternatively, or in addition, an AI/ML model 132 may be deployed at the LMF 130, for direct positioning or assisted positioning of the terminal device 110. Alternatively, or in addition, an AI/ML model may be deployed at all of the terminal device 110, network device 120, and LMF 130, for direct positioning or assisted positioning of the terminal device 110.

As used herein, the term “AI/ML model” may be interchangeably with the term “model”. The term “AI/ML model training” may refer to a process to train an AI/ML model for example by learning the input/output relationship and obtained the several features from the input/output for inference. The term “model monitoring” used herein may refer to a procedure that monitors the inference performance of the AI/ML model.

An AI/ML model configured for direct positioning of terminal devices may also be referred to as a direct AI/ML positioning model. The output of such AI/ML model inference is a location of a terminal device. The input to the direct AI/ML positioning model may comprise fingerprinting based on channel observation, channel observation such as channel impulse response (CIR), power delay profile (PDP), reference signal received power (RSRP), reference signal time difference (RSTD) and/or other types of channel observation, and/or the like.

An AI/ML model configured for assisted positioning of terminal devices may also be referred to as an AI/ML assisted positioning model. The output of such AI/ML model inference may comprise measurement and/or enhancement related information, which may be used to assist in determining a location of a terminal device. For example, the measurement and/or enhancement related information may include, but are not limited to, non-line of slight (NLOS)/line of sight (LOS) identification of a channel, timing and/or angle of measurement (e.g., time of arrival (ToA), time difference of arrival (TDoA)), path phase, likelihood of measurement, soft information/high resolution of RSTD, and/or the like. The input to the AI/ML assisted positioning model may be similar to or may include additional, fewer or different information form the input to the direct AI/ML positioning model.

There are several use cases of AI/ML based positioning accuracy enhancement. A first use case is UE-based positioning with a UE-side model, where the model may be a direct AI/ML or AI/ML assisted positioning model. A second use case is UE-assisted/LMF-based positioning with UE-side model, where the model may be an AI/ML assisted positioning model. A third use case is UE-assisted/LMF-based positioning with LMF-side model, where the model may be a direct AI/ML positioning model. A fourth use case is NG-RAN node assisted positioning with a gNB-side model (a model at the network device), where the model may be an AI/ML assisted positioning model. A fifth use case is NG-RAN node assisted positioning with a LMF-side model, where the model may be a direct AI/ML positioning model. It would be appreciated that there may be various other use cases for AI/ML based positioning.

In the embodiments illustrated in FIG. 1A, the AI/ML models 112, 122, and 132 may be the same or different, and may be of the same type or different types of direct AI/ML positioning model and AI/ML assisted positioning model.

In some embodiments, one or more of the AI/ML models 112, 122, and 132 may be trained offline using data collected from field. The offline training may refer to an AI/ML training process where the model is trained based on collected dataset, and where the trained model is later used or delivered for inference. It is noted that this definition only serves as a guidance. There may be cases that may not exactly conform to this definition but could still be categorized as offline training by commonly accepted conventions.

In some embodiments, one or more of the AI/ML models 112, 122, and 132 may be trained online using data collected from field. The online training may refer to an AI/ML training process where the model being used for inference) is (typically continuously) trained in (near) real-time with the arrival of new training samples. It is noted that the notion of (near) real-time or non real-time is context-dependent and is relative to the inference time-scale. It is also noted that this definition only serves as a guidance. There may be cases that may not exactly conform to this definition but could still be categorized as online training by commonly accepted conventions. In some embodiments, fine-tuning/re-training may be done via online or offline training.

In some embodiments, one or more of the AI/ML models 112, 122, and 132 may be trained and then applied locally. In some embodiments, one or more of the AI/ML models 112, 122, and 132 may be trained remotely and then transferred to the corresponding devices for use. For example, the AI/ML model 112 may be trained at the network device 120 or the LMF 130 and then transferred to the terminal device 110 for use. In some embodiments, there may be a separate entity in the communication environment 100, such as a model transfer entity 160 which is configured to train and transfer the trained AI/ML models 112, 122, and/or 132 to the corresponding devices for use. The model transfer entity 160 may comprise a network device in RAN or CN or may be a third-party entity.

A lifecycle of an AI/ML model at least involve a model training stage, a model reference stage, a model fine-tuning stage, and a model monitoring stage. At the model training stage, training datasets are used to train an AI/ML model. A training dataset generally comprises inputs of the AI/ML model and ground-truth data for the corresponding inputs. At a model reference stage, the trained AI/ML model is transferred to corresponding devices (e.g., the terminal device 110, the network device 120, and/or the LMF 130) to process actual inputs. For example, in the positioning scenario, the trained AI/ML model is provided to the terminal device 110 to determine its location or measurement and/or enhancement related information for positioning (depending on the type of the AI/ML model). During the model reference stage, the performance of the AI/ML model may be monitored.

In some situations, if the AI/ML model is deteriorating, the outputs for AI/ML based positioning and AI/ML-assisted positioning may deviate from the ground truth greatly. For example, if the environment of the terminal device changes, the AI/ML model may no longer output an accurate positioning result or intermediate measurement and/or enhancement related information for the terminal device located in the changed environment. In this case, the AI/ML model may need to be deactivated, fine-tuned, or replaced by new models.

The propagation environment may change due to various factors, e.g., moving of the terminal devices and new obstacles. Due to the large change of propagation environment, the performance of AI/ML based positioning may deteriorate dramatically. In order to avoid long time performance degradation, AI/ML model quality monitoring is needed, and some actions should be taken when the AI/ML model becomes invalid.

In some embodiments, the model monitoring may be implemented at the device where the AI/ML model is deployed, e.g., the terminal device 110 for the AI/ML model 112, the network device 120 for the AI/ML model 122, or the LMF 130 for the AI/ML model 132. In some embodiments, the model monitoring may be implemented at other devices than the device where the AI/ML model is deployed. For example, the network device 120 may be responsible for the model monitoring of both the AI/ML models 112 and 122. In some embodiments, there may be a separate entity in the communication environment 100, such as a model monitoring entity 170 which is configured for monitoring of the AI/ML models 112, 122, and/or 132 deployed in the communication environment 100. The model monitoring entity 170 may comprise a network device in RAN or CN or may be a third-party entity.

It has been proposed some metrics/methods for AI/ML model monitoring in lifecycle management per use case. In some embodiments, the model monitoring may be based on inference accuracy, including metrics related to intermediate key performance indicators (KPIs). In some embodiments, the model monitoring may be based on system performance, including metrics related to system performance KPIs. In some other embodiments, the model monitoring may be based on data distribution. The data distribution may be input-based, e.g., to monitor the validity of the AI/ML input, e.g., out-of-distribution detection, drift detection of input data, or something simple like checking Signal Noise Ratio (SNR), delay spread, etc. The data distribution may be alternatively or additionally output-based, e.g., to perform drift detection of output data from the model.

Some of the model monitoring solutions requires collection of ground-truth data (also referred to as ground-truth label) or its approximation for an AI/ML model to be monitored. To monitor (and train) an AI/ML model, the positioning related measurement results and associate ground-truth labels are used. For the direct AI/ML positioning, the ground truth labels are the location of the target terminal device. For the AI/ML assisted positioning, the ground truth labels are the ideal or actual information of the measurement/reporting (e.g., LOS/NLOS identification, RSTD, etc.). It is very important to obtain the ground truth labels, and it is obvious that the obtainment of ground truth labels requires non-AI means, e.g., base station/satellite positioning.

There are too many methods that have been implemented currently, some within the framework of 3GPP and some go beyond the 3GPP framework, while each of the positioning scheme has its own application scenario with optimal positioning accuracy. It is expected that reliable model monitoring source from reliable field data are used for monitoring the model.

The field data for model monitoring can be obtained efficiently and accurately by choosing an appropriate scheme based on the condition that trigger the AI/ML model. If the entities involved in model monitoring are aware of the reason why the AI/M model is triggered, it is helpful to collect more reliable field data for generating ground-truth label for model monitoring.

Example embodiments of the present disclosure provide an improved solution for ground-truth data collection for model monitoring. According to this solution, a first communication device (which may be configured for model monitoring of an AI/ML model) receives, from a second communication device, a model trigger condition indication or a model description related to the AI/ML model. The model trigger condition indication indicates a trigger condition for triggering the AI/ML model to be applied in direct positioning or assisted positioning of a terminal device. The model description comprising attribute information for ground-truth collection. The first communication device determines a target ground-truth collection mode for the AI/ML model based on the model trigger condition indication or the model description; and collects, based on the target ground-truth collection mode, ground-truth data for monitoring the AI/ML model. Through this solution, some additional information can be used to assist field data collection, especially for model monitoring. This can improve the reliability of model monitoring by indicating the reason of why the AI/ML model for positioning is triggered and applying the reason to initiate the positioning procedure for field data collection purpose.

Principles and implementations of the present disclosure will be described in detail below with reference to the figures.

FIG. 2 illustrates a signaling flow 200 of communications in accordance with some embodiments of the present disclosure. The signaling flow 200 involves a first communication device 201 and a second communication device 202.

The first communication device 201 may be an entity which is configured for model monitoring of one or more AI/ML models. An AI/ML model to be monitored may be transferred to any suitable communication device for direct positioning or assisted positioning of a terminal device. As some examples, the AI/ML model to be monitored may be the AI/ML model 112 deployed at the terminal device 110, the AI/ML model 122 deployed at the network device 120, or the AI/ML model 132 deployed at the LMF 130, or any other AI/ML models deployed in the communication environment. The first communication device 201 may be the device at which the AI/ML model is deployed (e.g., the terminal device 110, the network device 120, or the LMF 130), other device such as the AMF 140, or a separate entity which is configured for monitoring, such as the model monitoring entity 170. The actual entity to be implemented as the first communication device 201 may depend on the actual application. In some embodiments, there may be more than one communication device involved in ground-truth data collection for monitoring the AI/ML model. In this case, each involved communication device may be considered as a first communication device 201 and may perform similar operations as will be discussed with respect to the first communication device 201 in the following.

In the signaling flow 200, the first communication device 201 receives (210) from the second communication device 202, a model trigger condition indication or a model description related to the AI/ML model. The model trigger condition indication indicates a trigger condition for triggering the AI/ML model to be applied in direct positioning or assisted positioning of a terminal device. The model description comprises attribute information for ground-truth collection.

As mentioned, there are generally two types of sub-use cases for AI/ML based positioning, including direct AI/ML positioning in which the output of an AI/ML model inference is a UE location, and AI/ML assisted positioning in which the output of an AI/ML model is measurement and/or enhancement related information used to assist in determining the UE location. For model monitoring based on inference accuracy, the monitoring data may contain both the model input and ideal model output, i.e., pairs of {input, output} for the AI/ML mode. As some examples, for the direct AI/ML positioning, a pair of {input, output} may be include new measurements such as {CIR/PDP, UE location}, or existing measurement such as {RSRP/RSRPP/RSTD, UE location}. As some other examples, for the AI/ML assisted positioning, a pair of {input, output} may be include new measurements such as a new measurement report such as {CIR/PDP/RSRP/RSRPP/RSTD/ . . . , ToA/path phase}, an existing measurement report such as {CIR/PDP/RSRP/RSRPP/RSTD/ . . . , RSTD/(LOS/NLOS indicator)/RSRPP}, or enhancement of the existing measurement report such as {CIR/PDP/RSRP/RSRPP/RSTD/ . . . , soft information/high resolution of RSTD}.

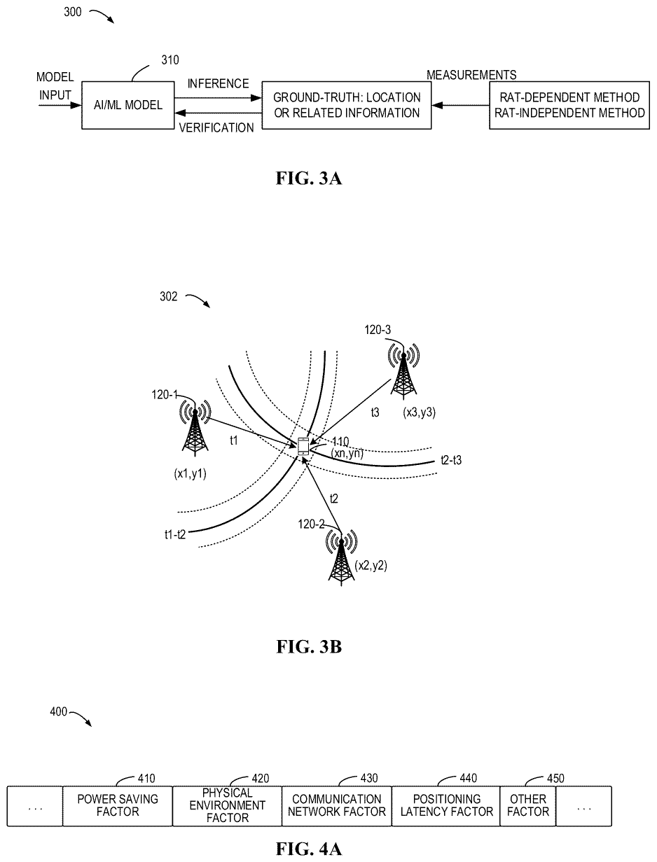

Each of the sub-use cases (i.e., the direct AI/ML positioning and AI/ML assisted positioning) requires the UE location (or related) information for model monitoring, which need verification by the AI/ML model. As illustrated in FIG. 3A, an example workflow 300 may include providing a model input to an AI/ML model 310 for inference, which thus output a location or related information as a ground-truth output that is needed for verification of the AI/ML model 310.

Unlike other use cases, it is impossible to monitor the AI/ML model by field data collected offline since it is difficult to “match” the model input (e.g., CIR/PDP and the like) and the model output (e.g., location) when the target terminal device is in a unpredictable physical environment. Although the UE location (or related) information can be obtained based on measurements using some radio access technology (RAT)-dependent methods and RAT-independent methods, e.g., observed time difference of arrival (OTDOA), multi-round-trip time (multi-RTT), or Global Navigation Satellite System (GNSS), the reliability of model monitoring is doubtful since the ground truth data may also be doubtful if the non-AI model methods may be one of the reasons why the AI/ML model is triggered for inferring the UE location or for enhancing the positioning accuracy. It is reasonable if the reason for triggering the AI/ML model is not due to unreliable of the non-AI model methods.

At least in view of the above, in embodiments of the present disclosure, it is proposed to provide an implicit way with some additional information to assist field data collection especially for model monitoring. Therefore, the model trigger condition indication is communicated to the first communication device 201, to indicates the trigger condition for triggering the AI/ML model in direct positioning or assisted positioning. Additionally or as an alternative, an explicit way are also provided combining with the current agreed cases. Therefore, the model description is defined to comprises attribute information for ground-truth collection. As such the model trigger condition indication or the attribute information for ground-truth collection can help the first communication device 201 to determine how reliable ground-truth data can be collected for the AI/ML model.

The second communication device 202 which transmits (205) the model trigger condition indication or the model description to the first communication device 201 may be any entity in the communication device that knows the trigger condition of the AI/ML model to be monitored by the first communication device 201, or any entity that can access and transfer the model description.

The first communication device 201 determines (215) a target ground-truth collection mode for the AI/ML model based on the model trigger condition indication or the model description, and collects (220), based on the target ground-truth collection mode, ground-truth data for monitoring the AI/ML model.

Before describing the determination of the target ground-truth collection, candidate ground-truth collection modes are first introduced.

There are various positioning schemes which can be adopted for collecting the locations of terminal devices or the related information as ground-truth data. Those positioning schemes may be considered as candidate ground-truth collection modes. Those positioning schemes may be categorized by application scenarios or by implementations. If the positioning schemes are categorized by application scenarios, there may be some outdoor positioning schemes and indoor positioning schemes.

The outdoor positioning schemes may include positioning schemes based on satellite positioning, such as Global Positioning System GPS, Galileo satellite navigation system, GLONAS, Beidou Navigation Satellite System (BDS), or the like, and base positioning schemes such as location based service (LBS). The principle for the positioning schemes based on satellite positioning may be based on triangulation, multilateral localization, and/or the like. The indoor positioning schemes may include positioning schemes based on WiFi localization, Radio Frequency Identification (RFID) localization, infrared localization, ultrasonic localization, Bluetooth localization, inertial navigation localization, ultra-wide band (UWB) localization, visible light localization, geomagnetic matching localization, visual localization, and/or the like. The principle for those positioning schemes may be based on proximity detection, centroiding, triangulation, multilateral localization, fingerprint, dead reckoning, and/or the like.

If the positioning schemes are categorized by implementations, there may be some RAT-dependent positioning schemes and RAT-independent positioning schemes.

The RAT-dependent positioning schemes refers to positioning schemes based on radio access technologies and thus may involve one or more RAN entities. Examples of RAT-dependent positioning schemes may include positioning schemes based on OTDOA, Uplink Time Difference of Arrival (UTDOA), downlink angle-of-departure (DL-AoD), uplink angles of arrival (UL-AoA), Multi-RTT, and/or the like. The RAT-independent positioning schemes refers to positioning schemes that are independent from radio access technologies and thus may not involve one or more RAN entities. Examples of RAT-independent positioning schemes may include the positioning schemes based on satellite positioning.

Example embodiments related to the model trigger condition indication and the model description will be described in the following.

The model trigger condition indication may be used as an implicit for determining how collect the field data implicitly. In some embodiments, the model trigger condition indication may indicate at least one of the following trigger conditions for triggering the AI/ML model, including a first trigger condition related a power saving factor, a second trigger condition related to a physical environment factor, a third trigger condition related to a communication network factor, or a fourth trigger condition related to a positioning latency factor. Each of those four factors may include one or more subcategories.

For the first trigger condition, the AI/ML model may be triggered for the reason of power saving factor. For the RAT-dependent positioning, the mean way is triangular positioning currently, which requires the transmission and/or reception of reference signaling. On the other hand, additional monitoring and calculating consumption of UE power is inevitable. Therefore, it is reasonable to trigger the AI/ML model to infer the UE location. In some embodiments, there may be some subcategories for the power saving factor, such as disablement of sounding reference signal (SRS) transmission, disablement of positioning reference signal (PRS), including monitoring, measurement, reporting of the reference signals, and/or the like.

For the second trigger condition, the AI/ML model may be triggered due to the physical environment factor since the positioning accuracy is greatly affected by the physical environment. In some embodiments, there may be some subcategories for the physical environment factor, including the indoor scenario (which determines the probability of LoS path), the poor reception performance of reference signaling, and/or the like.

For the third trigger condition, the AI/ML model may be triggered due to the communication network factor. In some examples, as illustrated in an example scenario 302 of FIG. 3B, it is assumed that the positioning scheme is triangulation-based, to determine a location (xn, yn) of the terminal device 110 through the observed time differences of arrival among the three network devices 120-1, 120-2, 120-3 whose locations (x1, y1), (x2, y2), and (x3, y3) are known. If there are network synchronization errors between the involved network devices, it may bring the error of UL/DL measurements at the terminal device and thus lead to positioning inaccuracy. In this case, the AI/ML model may be triggered. In addition to the network synchronization error, the communication network factor may include other subcategories such as the network device-terminal device synchronization error, the network device location error, poor UL hearability, and/or the like.

For the fourth trigger condition, the AI/ML model may be triggered due to some latency factors. The latency factors may include subcategories such as sparse reference signal (RS) resource, long measurement report period, and/or the like.

In some embodiments, the model trigger condition indication may include a placeholder for each of the above trigger conditions (or factors). A positioning scheme may involves multiple entities in current RAT-dependent method, e.g., the terminal device, the network device, and LMF. It is very likely that the AI/ML model for direct positioning or assisted positioning is triggered by any of the entities, and further by any of the factors dominated by any entity simultaneously. Using a placeholder for each factor can assist to indicate more than one factor to the first communication device 201 for data collection, to determine whether it can use the RAT-dependent positioning or RAN-independent to obtain efficient and reliable field data to improve the reliability of monitoring. In some embodiments, each bit of the placeholder may represent whether the corresponding trigger condition is the incentive to trigger the AI/ML model.

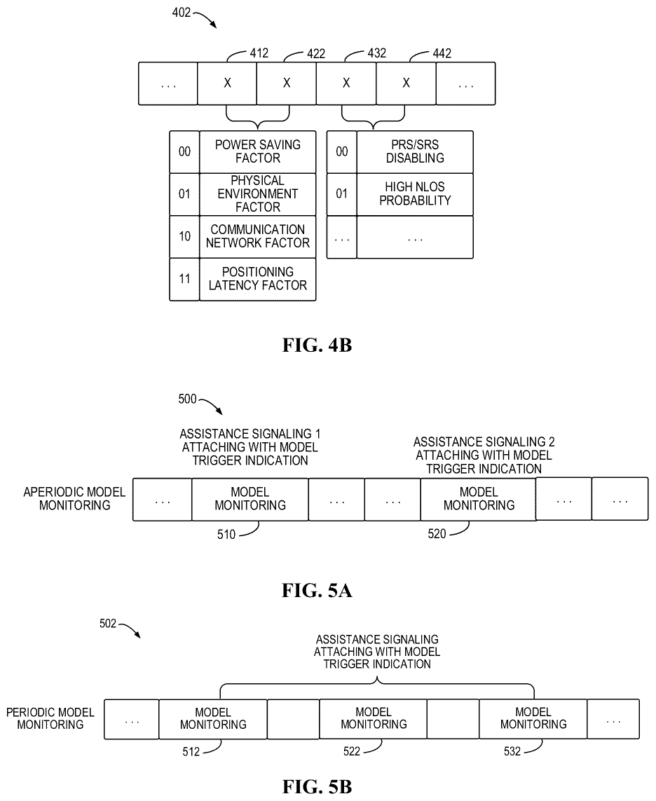

FIG. 4A illustrates an example format 400 of model trigger condition indication in accordance with some embodiments of the present disclosure. As shown, if the first trigger condition 410 related to the power saving factor is 1, the reliable field data for model monitoring can still be collected with additional power consumption. If the second trigger condition 420 related to the related to the physical environment factor or the third trigger condition 430 related to the communication network factor is 1, the reliable field data for model monitoring can still be collected with other mechanisms like RAT-independent methods. If the fourth trigger condition 440 related to the latency factor or network factor or the third trigger condition 430 related to the communication network factor is 1, the reliable field data for model monitoring still can be collected with on-demand requests. In some examples, the model trigger condition indication may include other bits, such as a bit to indicate a trigger condition related to other factors (not the four factors discussed above). Such a model trigger condition indication can mingle multiple factors to indicate the trigger condition(s) for the AI/ML model. That is, the model trigger condition indication may indicate that the AI/ML model can be triggered due to more than one factor.

In some embodiments, if one or more trigger conditions are indicated (e.g. the AI/ML model is triggered due to the power saving factor) but not all the trigger conditions are indicated, the first communication device 201 may determine a target ground-truth collection mode which allow filed data collection without the consideration the limitation of this condition (e.g. ignoring the power saving reason during the positioning). It would be appreciated that the target ground-truth collection mode may be determined in any other ways with respect to the indicated trigger condition(s).

In some embodiments, if all of the trigger conditions are indicated, e.g., the model trigger condition indication is 1111, which represents that it is unable to collect reliable field data to monitor the AI/ML model currently by non-AI means, then the first communication device 201 may transmit, to at least one third communication device at which field data is collected for model monitoring, a request to deactivate or suspend the AI/ML model for direct positioning or assisted positioning of the terminal device. Since model monitoring for the AI/ML model is ineffective, it is reasonable to deactivate or suspend this AI/ML model as its performance is not assured. The direct positioning or assisted positioning may be implemented by switching to a new AI/ML model. In some embodiments, the first communication device 201 may transmit a request to replace to other methods to monitor the AI/ML model.

In some embodiments, if no trigger condition is indicated, e.g., the model trigger condition indication is 0000, which represents reliable that field data for monitoring the AI/ML model can be collected by any of ground-truth collection mode currently, thus a priority for current positioning methods, e.g. OTDOA, multi-RTT, GNSS, etc., can be predefined to selection a ground-truth collection mode for ground-truth data collection. The first communication device 201 may select the target ground-truth collection mode from a plurality of candidate ground-truth collection modes based on respective priorities of the plurality of candidate ground-truth collection modes, where a candidate ground-truth collection mode is related to at least one of the first trigger condition, the second trigger condition, the third trigger condition, or the fourth trigger condition. For example, the first communication device 201 may prioritize to utilize the OTDOA positioning methods to obtain the ground truth labels for the AI/ML model when all of the methods are available.

In some embodiments, the model trigger condition indication may indicate enablement or disablement of a ground-truth collection mode of RAT-dependent positioning or RAT-independent positioning. For example, one bit in the model trigger condition indication may be used to represent whether a specific positioning method (categorized in RAT-dependent positioning or RAT-independent positioning) can be enabled to collect field data to monitor the AI/ML model for positioning. Additionally, in some embodiments, a confidence degree of the RAT-dependent positioning may also be provided in association with the enablement/disablement indicator additionally. Such an indication is simple and with low-overhead. The first communication device 201 may determine, based on such a model trigger condition indication, the target ground-truth collection mode as the ground-truth collection mode based on RAT-dependent positioning or RAT-independent positioning.

In some embodiments, one or more of the first trigger condition, the second trigger condition, the third trigger condition, or the fourth trigger condition may each comprise a plurality of subcategories of trigger conditions. In this case, the model trigger condition indication may be designed to specifically indicate at least one of the plurality of subcategories of trigger conditions for triggering the AI/ML model. In some embodiments, the model trigger condition indication may comprise a bitmap for the specific trigger conditions. A predefined table may be adopted to indicate the specific trigger conditions that trigger the AI/ML model for positioning. For example, one or more Most Significant Bit (MSB) bit(s) represent the categories (e.g., the four trigger conditions as mentioned above, and one or more Lowest Significant Bit (LSB) bit(s) represent the specific subcategories of trigger conditions.

FIG. 4B illustrates an example format 402 of model trigger condition indication in accordance with some embodiments of the present disclosure. As illustrate, two MSB bits 412, 422 are used to indicate the four trigger conditions related to the power saving, physical environment, communication network and positioning latency factors. Two LSB bits 432, 442 are used to indicate the specific trigger conditions related to the corresponding indicated trigger conditions by the two MSB bits. In this way, a specific condition can be indicated to assist the first communication device to determine how to collect field data for model monitoring. It would be appreciated that any other formats may also be defined to indicate the specific conditions.

In some embodiments, there may be various occasions for the first communication device 201 to receive the trigger condition(s) of triggering AI/ML model for direct positioning or assisted positioning. In some embodiments, if the AI/ML model to be monitored is also deployed at the first communication device 201 for inference, the model trigger condition indication may be associated with the transferring of the AI/ML model, e.g., followed with AI/ML model transfer. For example, additional bits of the model trigger condition indication may be attached with the AI/ML model to indicate why this model is needed. The way of transmitting the triggering condition depends on the way of model transfer. In some embodiments, the model trigger condition indication may be associated with a reception of an activation request that activate the AI/ML model deployed at the first communication device 201, e.g., followed with the AI/ML model activation/switching indicator. Thus, this way of transmitting the triggering condition depends on the way of model activation, e.g., in downlink control information (DCI), media access control control element (MAC CE) or radio resource control (RRC) signaling.

In some embodiments, the model trigger condition indication may be associated with a reception of a monitoring request for the AI/ML model, e.g., followed with the related assistance signaling or configuration AI/ML model monitoring, including both aperiodic model monitoring and periodic model monitoring. FIG. 5A illustrates an example model monitoring occasion pattern 500, i.e., aperiodic model monitoring, where aperiodic occasions 510 and 520 for model monitoring may be indicated by Assistance Signaling 1 and Assistance Signaling 2, each attaching with the model trigger condition indication. FIG. 5B illustrates an example model monitoring occasion pattern 502, i.e., periodic model monitoring, where periodic occasions 512, 522, 532 for model monitoring may be indicated by single Assistance Signaling attaching with the model trigger condition indication.

As an alternative, or in addition to the model trigger condition indication, the first communication device 201 receives the model description to determine the target ground-truth collection mode for field data collection. The model description is used to configure or transfer the AI/ML model for inference, generally including a configuration profile related to the AI/ML model. In embodiments of the present disclosure, the model description further include attribute information for ground-truth collection, to explicitly indicate the target ground-truth collection mode for the AI/ML model. That is, the target ground-truth collection mode for collecting field data may also be regarding as an attribute of the AI/ML model, which is contained in the model description and indicated along with the model description to the specific entity, i.e., the first communication device 201. In some embodiments, the first communication device 201 may be the entity at which the AI/ML model is deployed for inference. In some embodiments, the first communication device 201 may receive, from the second communication device 202, the model description in the model transfer of the AI/ML model, e.g., followed with AI/ML model transfer. For example, additional bits of the model trigger condition indication may be attached with the AI/ML model to indicate why this model is needed.

As an example, the model description can be as follows in Table 1.

TABLE 1

```
AI/ML model {
  Functionality: positioning
  ID: 1
  ...
  Ground-truth collection method: one of the way
  from {OTDOA positioning/A-
GNSS positioning/Enhanced Cell ID positioning/...}
...
}
```

With the target ground-truth collection mode determined and ground-truth data collected, the first communication device 201 may perform monitor of the AI/ML model using the collected ground-truth data. The ground-truth collection and the model monitoring may involve other entities than the first communication device 201.

In some embodiments, other information may also be contained in the model description signaling. Specifically, the model description may further comprise attribute information for a model monitoring mode, such as an input-based model monitoring mode or an output-based model monitoring mode. In response to the model monitoring mode, the first communication device 201 may perform monitor of the AI/ML model using the collected ground-truth data based on the model monitoring mode.

In some embodiments, in addition to the entity for performing model monitoring (i.e., the first communication device 201), other entities may also need the condition(s) for triggering the AI/ML model or the attribute information for ground-truth collection, including the entity for model inference, such as a fourth communication device at which the AI/ML model is deployed for inference. Wherever the entity for model monitoring is, the fourth communication device at which the AI/ML model is deployed for inference may always be informed with the reason why the AI/ML model for positioning is triggered. In such embodiments, the second communication device 202 may also transmit the model trigger condition indication and/or the model description to the fourth communication device. In some embodiments, other entities, such as the entities for model training, model selection, update, deactivation, selection, switching, fallback, or the like, may also be provided with the model trigger condition indication and/or the model description.

In some embodiments, it is assumed that the entity for model monitoring (i.e., the first communication device 201) just refers to where the comparison between model inference and ground truth implement and no determination involved.

As mentioned above, there are several use cases of AI/ML based positioning accuracy enhancement. In some embodiments, if the first communication device 201 is a network device or a location management function (LMF) at which the AI/ML model is deployed for direct positioning or assisted positioning of the terminal device, the first communication device 201 may transmit, to an AMF (e.g., the AMF 150), a location service request related to the terminal device.

In some embodiments, in a first use case of UE-based positioning with a UE-side model, since model inference is performed entirely at the terminal device side, wherever the entity for model monitoring is, the terminal device (e.g., the terminal device 110 in the communication environment 100) may always be informed with the reason why the AI/ML model for positioning is triggered, e.g., may receive the model trigger condition indication and/or the model description. For direct AI/ML positioning, the ground truth data, i.e., UE location, in field data may source from RAN-dependent and/or RAN-independent architecture if they are triggered. In some embodiments, according to the model trigger condition, the terminal device 110 may determine whether to request some location service (e.g., positioning or delivery of assistance data) to the serving AMF 140 when considering RAT-dependent positioning. In some embodiments, according to the model trigger condition, the terminal device 110 may determine whether to start the procedure (e.g., request location related information from specific hardware modules) if the RAT-independent positioning is available. In some embodiments, for AI/ML assisted AI/ML positioning, according to the model trigger condition, the ground-truth data, e.g., the LoS/NLOS indicator, RSRP, or the like, in field data may be transformed from the result of UE based positioning, or measurement from other UL/DL reference signaling.

In some embodiments, in a second use case of UE-assisted/LMF-based positioning with UE-side model, since model inference is performed entirely at the terminal device side, wherever the entity for model monitoring is, the terminal device (e.g., the terminal device 110 in the communication environment 100) may always be informed with the reason why the AI/ML model for positioning is triggered, e.g., may receive the model trigger condition indication and/or the model description. The ground truth data, e.g., the LoS/NLOS indicator, RSRP, or the like in field data may be transformed from the results of UE based positioning, or measurement from other UL/DL reference signaling.

In some embodiments, in a fourth use case of NG-RAN node assisted positioning with an gNB-side model (a model at the network device), since model inference is performed entirely at the network device side, wherever the entity for model monitoring is, the network device (e.g., the network device 120 in the communication environment 100) may always be aware of the reason why the AI/ML model for positioning is triggered from itself or additional informing of the terminal device 110 or the LMF 130. The ground truth data, e.g., the LoS/NLOS indicator, RSRP, or the like in field data may be transformed from the results of UE based or UE assisted positioning that requested from the gNB side, from the results of RAN-independent positioning that transmitted from UE side, or the measurement from other UL/DL reference signaling.

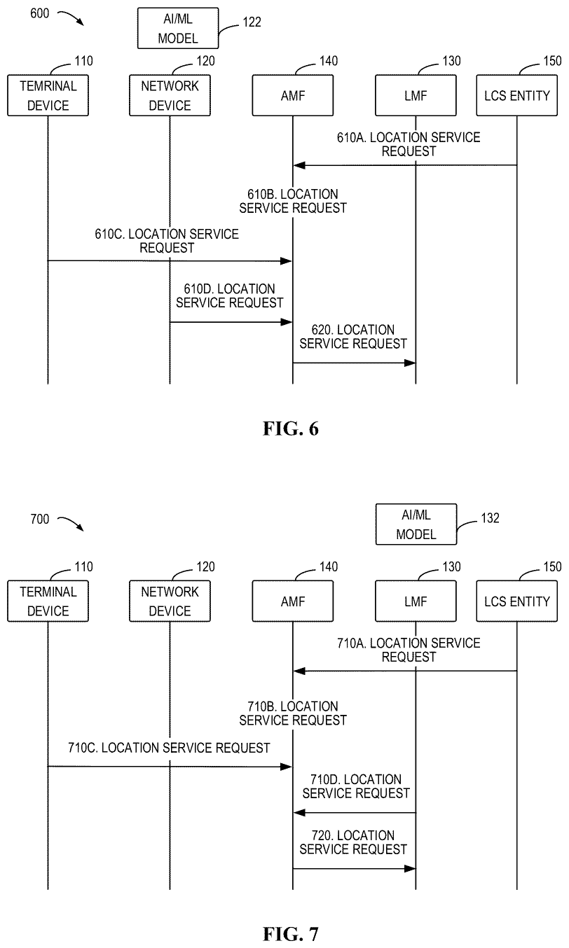

FIG. 6 illustrates a signaling flow 600 of an example positioning procedure with the AI/ML model 122 at the network device 120 side, i.e., in the fourth use case. In operation, the positioning of the terminal device 110 is triggered for various reasons. For example, some LCS entity 15 requests (610a) some location service (e.g. positioning) for a terminal device 110 to the serving AMF 140. Alternatively, the serving AMF 140 for the terminal device 110 determines (610b) the need for some location service (e.g., to locate the terminal device 110 for an emergency call). Alternatively, the terminal device 110 requests (610c) some location service (e.g. positioning or delivery of assistance data) to the serving AMF 140 at the non-access stratum (NAS) level. Alternatively, the network device 120 for the target terminal device 110 to be positioned requests (610d) some location service (e.g. positioning or delivery of assistance data) to the serving AMF 140. The AMF 140 transfers (620) the location service request to an LMF 130.

In some embodiments, in a third use case is UE-assisted/LMF-based positioning with LMF-side model, since model inference is performed entirely at the LMF side, wherever the entity for model monitoring is, an LMF (e.g., the LMF 130 in the communication environment 100) may always be aware of the reason why the AI/ML model for positioning is triggered. For direct AI/ML positioning, the ground truth, i.e., UE location, in field data may be source from the RAN-dependent and/or RAN-independent architecture if they are triggered. In some embodiments, according to the model trigger condition, the LMF 130 may determine whether to request some location service (e.g., positioning or delivery of assistance data) to serving AMF when considering RAN-dependent positioning. In some embodiments, according to the model trigger condition, the LMF 130 may determine whether to indicate the UE to start the procedure (e.g. request location related information from specific hardware modules) if RAN-independent positioning is available by a new LTE Positioning Protocol (LPP) message. For AI/ML assisted AI/ML positioning, according to the model trigger condition, the ground-truth data, e.g., the LoS/NLOS indicator, RSRP, or the like in field data source may be transformed from the result of UE reported positioning, or measurement from other UL/DL reference signaling from the network device.

FIG. 7 illustrates a signaling flow 700 of an example positioning procedure with the AI/ML model 132 at the LMF 130 side in accordance with some further embodiments of the present disclosure. In operation, the positioning of the terminal device 110 is triggered for various reasons. For example, some LCS entity 15 requests (710a) some location service (e.g. positioning) for a terminal device 110 to the serving AMF 140. Alternatively, the serving AMF 140 for the terminal device 110 determines (710b) the need for some location service (e.g., to locate the terminal device 110 for an emergency call). Alternatively, the terminal device 110 requests (710c) some location service (e.g. positioning or delivery of assistance data) to the serving AMF 140 at the non-access stratum (NAS) level. Alternatively, the serving LMF 130 for the target terminal device 110 to be positioned requests (710d) some location service (e.g. positioning or delivery of assistance data) to the serving AMF 140. The AMF 140 transfers (720) the location service request to an LMF 130.

In some embodiments, in a fifth use case is NG-RAN node assisted positioning with a LMF-side model, since model inference is performed entirely at the LMF side, wherever the entity for model monitoring is, the LMF 130 may always be aware of the reason why the AI/ML model for positioning is triggered. For direct AI/ML positioning, the ground truth, i.e., UE location, in field data may be sourced from the RAN-dependent and/or RAN-independent architecture if they are triggered, and the measurement is reported by the serving network device. In some embodiments, according to the model trigger condition, the LMF 130 may determine whether to request some location service (e.g., positioning or delivery of assistance data) to the serving AMF 130 when considering RAN-dependent positioning, where the positioning is performed by UL SRS positioning. For AI/ML assisted AI/ML positioning, according to the model trigger condition, the ground truth, e.g., the LoS/NLOS indicator, RSRP, or the like in field data source may be transformed from the result of UE based RAN-independent positioning, or measurement from other UL/DL reference signaling.

It has been provided several ways to collect field data for both direct AI/ML positioning and AI/ML assisted AI/ML positioning in different use cases.

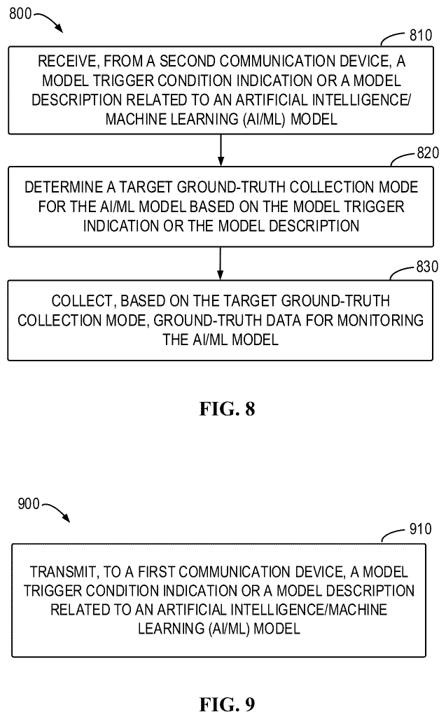

FIG. 8 illustrates a flowchart of a communication method 800 implemented at a first communication device in accordance with some embodiments of the present disclosure. For the purpose of discussion, the method 800 will be described from the perspective of the first communication device 201 in FIG. 2.

At block 810, the first communication device 201 receives, from a second communication device (e.g., the second communication device 202 in FIG. 2), a model trigger condition indication or a model description related to an artificial intelligence/machine learning (AI/ML) model, the model trigger condition indication indicating a trigger condition for triggering the AI/ML model to be applied in direct positioning or assisted positioning of a terminal device, and the model description comprising attribute information for ground-truth collection.

At block 820, the first communication device 201 determines a target ground-truth collection mode for the AI/ML model based on the model trigger condition indication or the model description.

At block 830, the first communication device 201 collects, based on the target ground-truth collection mode, ground-truth data for monitoring the AI/ML model.

In some example embodiments, the model trigger condition indication indicates at least one of the following trigger conditions for triggering the AI/ML model: a first trigger condition related a power saving factor, a second trigger condition related to a physical environment factor, a third trigger condition related to a communication network factor, or a fourth trigger condition related to a positioning latency factor.

In some example embodiments, the method 800 further comprises: in accordance with a determination that all of the first trigger condition, the second trigger condition, the third trigger condition, and the fourth trigger condition are indicated, transmitting, to at least one third communication device at which field data is collected for model monitoring, a request to deactivate the AI/ML model for direct positioning or assisted positioning of the terminal device.

In some example embodiments, determining the target ground-truth collection mode comprises: in accordance with a determination that none of the first trigger condition, the second trigger condition, the third trigger condition, or the fourth trigger condition is indicated, selecting the target ground-truth collection mode from a plurality of candidate ground-truth collection modes based on respective priorities of the plurality of candidate ground-truth collection modes, wherein a candidate ground-truth collection mode is related to at least one of the first trigger condition, the second trigger condition, the third trigger condition, or the fourth trigger condition.

In some example embodiments, at least one of the first trigger condition, the second trigger condition, the third trigger condition, or the fourth trigger condition comprises a plurality of subcategories of trigger conditions, and wherein the model trigger condition indication further indicates at least one of the plurality of subcategories of trigger conditions for triggering the AI/ML model to be applied in direct positioning or assisted positioning of the terminal device.

In some example embodiments, the model trigger condition indication further indicates enablement or disablement of a ground-truth collection mode based on radio access technology (RAT)-dependent positioning or RAT-independent positioning. In some example embodiments, determining the target ground-truth collection mode comprises: determining, based on the model trigger condition indication, the target ground-truth collection mode as the ground-truth collection mode based on RAT-dependent positioning or RAT-independent positioning.

In some example embodiments, the AI/ML model is deployed at the first communication device. In some example embodiments, receiving the model trigger condition indication comprises: receiving, from the second communication device, the model trigger condition indication in at least one of the following: in model transfer of the AI/ML model, in an activation request to activate the AI/ML model deployed at the first communication device, or in a monitoring request for the AI/ML model.

In some example embodiments, the AI/ML model is deployed at the first communication device, and the model description further comprises attribute information for a model monitoring mode. In some example embodiments, receiving the model description comprises receiving, from the second communication device, the model description in model transfer of the AI/ML model. In some example embodiments, the method 800 further comprises performing monitoring of the AI/ML model using the collected ground-truth data based on the model monitoring mode.

In some example embodiments, the first communication device is a network device or a location management function (LMF) at which the AI/ML model is deployed for direct positioning or assisted positioning of the terminal device. In some example embodiments, the method 800 further comprises: transmitting, to an access and mobility management function (AMF), a location service request related to the terminal device.

FIG. 9 illustrates a flowchart of a communication method 900 implemented at a second communication device in accordance with some embodiments of the present disclosure. For the purpose of discussion, the method 900 will be described from the perspective of the second communication device 202 in FIG. 2.

At block 910, the second communication device 202 transmits to a first communication device (e.g., the first communication device 201 in FIG. 2), a model trigger condition indication or a model description related to an artificial intelligence/machine learning (AI/ML) model, the model trigger condition indication indicating a trigger condition for triggering the AI/ML model to be applied in direct positioning or assisted positioning of a terminal device, and the model description comprising attribute information for ground-truth collection. The first communication device is configured for monitoring the AI/ML model, and a target ground-truth collection mode for collecting ground-truth data of the AI/ML model is determined based on the model trigger condition indication or the model description.

In some example embodiments, the method 900 further comprises: transmitting, to a fourth communication device at which the AI/ML model is deployed, the model trigger condition indication or the model description.

In some example embodiments, the model trigger condition indication indicates at least one of the following trigger conditions for triggering the AI/ML model: a first trigger condition related a power saving factor, a second trigger condition related to a physical environment factor, a third trigger condition related to a communication network factor, or a fourth trigger condition related to a positioning latency factor.

In some example embodiments, at least one of the first trigger condition, the second trigger condition, the third trigger condition, or the fourth trigger condition comprises a plurality of subcategories of trigger conditions, and wherein the model trigger condition indication further indicates at least one of the plurality of subcategories of trigger conditions for triggering the AI/ML model to be applied in direct positioning or assisted positioning of the terminal device.

In some example embodiments, the model trigger condition indication further indicates enablement or disablement of a ground-truth collection mode based on radio access technology (RAT)-dependent positioning or RAT-independent positioning.

In some example embodiments, the AI/ML model is deployed at the first communication device. In some example embodiments, transmitting the model trigger condition indication comprises: transmitting, to the first communication device, the model trigger condition indication in at least one of the following: in model transfer of the AI/ML model, in an activation request to activate the AI/ML model deployed at the first communication device, or in a monitoring request for the AI/ML model.

In some example embodiments, the AI/ML model is deployed at the first communication device. In some example embodiments, transmitting, the model description comprises: transmitting, to the first communication device, the model description in model transfer of the AI/ML model. In some example embodiments, a model monitoring mode for the AI/ML model is further inserted in the model description.

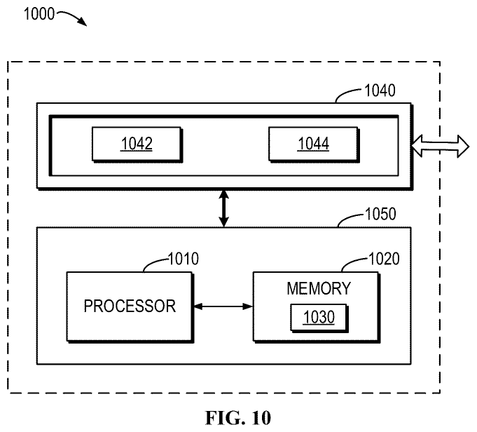

FIG. 10 is a simplified block diagram of a device 1000 that is suitable for implementing embodiments of the present disclosure. The device 1000 can be considered as a further example implementation of any of the devices as shown in FIG. 1A and FIG. 2.

As shown, the device 1000 includes a processor 1010, a memory 1020 coupled to the processor 1010, a suitable transceiver 1040 coupled to the processor 1010, and a communication interface coupled to the transceiver 1040. The memory 1010 stores at least a part of a program 1030. The transceiver 1040 may be for bidirectional communications or a unidirectional communication based on requirements. The transceiver 1040 may include at least one of a transmitter 1042 and a receiver 1044. The transmitter 1042 and the receiver 1044 may be functional modules or physical entities. The transceiver 1040 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1030 is assumed to include program instructions that, when executed by the associated processor 1010, enable the device 1000 to operate in accordance with the embodiments of the present disclosure, as discussed herein with reference to FIGS. 2 to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

According to embodiments of the present disclosure, a first communication device comprises a circuitry is provided. The circuitry is configured to: receive, from a second communication device, a model trigger condition indication or a model description related to an artificial intelligence/machine learning (AI/ML) model, the model trigger condition indication indicating a trigger condition for triggering the AI/ML model to be applied in direct positioning or assisted positioning of a terminal device, and the model description comprising attribute information for ground-truth collection; determine a target ground-truth collection mode for the AI/ML model based on the model trigger condition indication or the model description; and collect, based on the target ground-truth collection mode, ground-truth data for monitoring the AI/ML model. According to embodiments of the present disclosure, the circuitry may be configured to perform any method implemented by the first communication device as discussed above.

According to embodiments of the present disclosure, a second communication device comprises a circuitry is provided. The circuitry is configured to: transmit, to a first communication device, a model trigger condition indication or a model description related to an artificial intelligence/machine learning (AI/ML) model, the model trigger condition indication indicating a trigger condition for triggering the AI/ML model to be applied in direct positioning or assisted positioning of a terminal device, and the model description comprising attribute information for ground-truth collection, wherein the first communication device is configured for monitoring the AI/ML model, and a target ground-truth collection mode for collecting ground-truth data of the AI/ML model is determined based on the model trigger condition indication or the model description. According to embodiments of the present disclosure, the circuitry may be configured to perform any method implemented by the second communication device as discussed above.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following aspects.

In an aspect, it is proposed a first communication device comprising: a processor configured to cause the first communication device to: receive, from a second communication device, a model trigger condition indication or a model description related to an artificial intelligence/machine learning (AI/ML) model, the model trigger condition indication indicating a trigger condition for triggering the AI/ML model to be applied in direct positioning or assisted positioning of a terminal device, and the model description comprising attribute information for ground-truth collection; and determine a target ground-truth collection mode for the AI/ML model based on the model trigger condition indication or the model description; and collect, based on the target ground-truth collection mode, ground-truth data for monitoring the AI/ML model.

In some embodiments, the model trigger condition indication indicates at least one of the following trigger conditions for triggering the AI/ML model: a first trigger condition related a power saving factor, a second trigger condition related to a physical environment factor, a third trigger condition related to a communication network factor, or a fourth trigger condition related to a positioning latency factor.

In some embodiments, the processor is further configured to cause the first communication device to: in accordance with a determination that all of the first trigger condition, the second trigger condition, the third trigger condition, and the fourth trigger condition are indicated, transmit, to at least one third communication device at which field data is collected for model monitoring, a request to deactivate the AI/ML model for direct positioning or assisted positioning of the terminal device.

In some embodiments, the processor is further configured to cause the first communication device to: in accordance with a determination that none of the first trigger condition, the second trigger condition, the third trigger condition, or the fourth trigger condition is indicated, select the ground-truth collection mode from a plurality of candidate ground-truth collection modes based on respective priorities of the plurality of candidate ground-truth collection modes, wherein a candidate ground-truth collection mode is related to at least one of the first trigger condition, the second trigger condition, the third trigger condition, or the fourth trigger condition.

In some embodiments, at least one of the first trigger condition, the second trigger condition, the third trigger condition, or the fourth trigger condition comprises a plurality of subcategories of trigger conditions, and wherein the model trigger condition indication further indicates at least one of the plurality of subcategories of trigger conditions for triggering the AI/ML model to be applied in direct positioning or assisted positioning of the terminal device.

In some embodiments, the model trigger condition indication further indicates enablement or disablement of a ground-truth collection mode based on radio access technology (RAT)-dependent positioning or RAT-independent positioning; and wherein the processor is configured to cause the first communication device to: determine, based on the model trigger condition indication, the target ground-truth collection mode as the ground-truth collection mode based on RAT-dependent positioning or RAT-independent positioning.

In some embodiments, the AI/ML model is deployed at the first communication device, and wherein the processor is configured to cause the first communication device to: receive, from the second communication device, the model trigger condition indication in at least one of the following: in model transfer of the AI/ML model, in an activation request to activate the AI/ML model deployed at the first communication device, or in a monitoring request for the AI/ML model.

In some embodiments, the AI/ML model is deployed at the first communication device, and the model description further comprises attribute information for a model monitoring mode, wherein the processor is configured to cause the first communication device to: receive, from the second communication device, the model description in model transfer of the AI/ML model, and wherein the processor is further configured to cause the first communication device to: perform monitoring of the AI/ML model using the collected ground-truth data based on the model monitoring mode.

In some embodiments, the first communication device is a network device or a location management function (LMF) at which the AI/ML model is deployed for direct positioning or assisted positioning of the terminal device, and wherein the processor is further configured to cause the first communication device to: transmit, to an access and mobility management function (AMF), a location service request related to the terminal device.

In an aspect, it is proposed a second communication device comprising: a processor configured to cause the second communication device to: transmit, to a first communication device, a model trigger condition indication or a model description related to an artificial intelligence/machine learning (AI/ML) model, the model trigger condition indication indicating a trigger condition for triggering the AI/ML model to be applied in direct positioning or assisted positioning of a terminal device, and the model description comprising attribute information for ground-truth collection, wherein the first communication device is configured for monitoring the AI/ML model, and a target ground-truth collection mode for collecting ground-truth data of the AI/ML model is determined based on the model trigger condition indication or the model description.

In some embodiments, the processor is further configured to cause the second communication device to: transmit, to a fourth communication device at which the AI/ML model is deployed, the model trigger condition indication or the model description.

In some embodiments, the model trigger condition indication indicates at least one of the following trigger conditions for triggering the AI/ML model: a first trigger condition related a power saving factor, a second trigger condition related to a physical environment factor, a third trigger condition related to a communication network factor, or a fourth trigger condition related to a positioning latency factor.

In some embodiments, at least one of the first trigger condition, the second trigger condition, the third trigger condition, or the fourth trigger condition comprises a plurality of subcategories of trigger conditions, and wherein the model trigger condition indication further indicates at least one of the plurality of subcategories of trigger conditions for triggering the AI/ML model to be applied in direct positioning or assisted positioning of the terminal device.

In some embodiments, the model trigger condition indication further indicates enablement or disablement of a ground-truth collection mode based on radio access technology (RAT)-dependent positioning or RAT-independent positioning.

In some embodiments, the AI/ML model is deployed at the first communication device, and wherein the processor is configured to cause the second communication device to: transmit, to the first communication device, the model trigger condition indication in at least one of the following: in model transfer of the AI/ML model, in an activation request to activate the AI/ML model deployed at the first communication device, or in a monitoring request for the AI/ML model.

In some embodiments, the AI/ML model is deployed at the first communication device, and wherein the processor is configured to cause the second communication device to: transmit, to the first communication device, the model description in model transfer of the AI/ML model, wherein a model monitoring mode for the AI/ML model is further inserted in the model description.

In an aspect, a first communication device comprises: at least one processor; and at least one memory coupled to the at least one processor and storing instructions thereon, the instructions, when executed by the at least one processor, causing the device to perform the method implemented by the first communication device discussed above.

In an aspect, a second communication device comprises: at least one processor; and at least one memory coupled to the at least one processor and storing instructions thereon, the instructions, when executed by the at least one processor, causing the device to perform the method implemented by the second communication device discussed above.

In an aspect, a computer readable medium having instructions stored thereon, the instructions, when executed on at least one processor, causing the at least one processor to perform the method implemented by the first communication device discussed above.

In an aspect, a computer readable medium having instructions stored thereon, the instructions, when executed on at least one processor, causing the at least one processor to perform the method implemented by the second communication device discussed above.

In an aspect, a computer program comprising instructions, the instructions, when executed on at least one processor, causing the at least one processor to perform the method implemented by the first communication device discussed above.

In an aspect, a computer program comprising instructions, the instructions, when executed on at least one processor, causing the at least one processor to perform the method implemented by the second communication device discussed above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first communication device comprising:
a processor configured to cause the first communication device to:
receive, from a second communication device, a model trigger condition indication or a model description related to an artificial intelligence/machine learning (AI/ML) model, the model trigger condition indication indicating a trigger condition for triggering the AI/ML model to be applied in direct positioning or assisted positioning of a terminal device, and the model description comprising attribute information for ground-truth collection;
determine a target ground-truth collection mode for the AI/ML model based on the model trigger condition indication or the model description; and
collect, based on the target ground-truth collection mode, ground-truth data for monitoring the AI/ML model.

2. The device of claim 1, wherein the model trigger condition indication indicates at least one of the following trigger conditions for triggering the AI/ML model:
a first trigger condition related a power saving factor,
a second trigger condition related to a physical environment factor,
a third trigger condition related to a communication network factor, or
a fourth trigger condition related to a positioning latency factor.

3. The device of claim 2, wherein the processor is further configured to cause the first communication device to:
in accordance with a determination that all of the first trigger condition, the second trigger condition, the third trigger condition, and the fourth trigger condition are indicated,
transmit, to at least one third communication device at which field data is collected for model monitoring, a request to deactivate the AI/ML model for direct positioning or assisted positioning of the terminal device.

4. The device of claim 2, wherein the processor is further configured to cause the first communication device to:
in accordance with a determination that none of the first trigger condition, the second trigger condition, the third trigger condition, or the fourth trigger condition is indicated,
select the target ground-truth collection mode from a plurality of candidate ground-truth collection modes based on respective priorities of the plurality of candidate ground-truth collection modes, wherein a candidate ground-truth collection mode is related to at least one of the first trigger condition, the second trigger condition, the third trigger condition, or the fourth trigger condition.

5. The device of claim 2, wherein at least one of the first trigger condition, the second trigger condition, the third trigger condition, or the fourth trigger condition comprises a plurality of subcategories of trigger conditions, and
wherein the model trigger condition indication further indicates at least one of the plurality of subcategories of trigger conditions for triggering the AI/ML model to be applied in direct positioning or assisted positioning of the terminal device.

6. The device of claim 1, wherein the model trigger condition indication further indicates enablement or disablement of a ground-truth collection mode based on radio access technology (RAT)-dependent positioning or RAT-independent positioning; and
wherein the processor is configured to cause the first communication device to:
determine, based on the model trigger condition indication, the target ground-truth collection mode as the ground-truth collection mode based on RAT-dependent positioning or RAT-independent positioning.

7. The device of claim 1, wherein the AI/ML model is deployed at the first communication device, and wherein the processor is configured to cause the first communication device to:
receive, from the second communication device, the model trigger condition indication in at least one of the following:
in model transfer of the AI/ML model,
in an activation request to activate the AI/ML model deployed at the first communication device, or
in a monitoring request for the AI/ML model.

8. The device of claim 1, wherein the AI/ML model is deployed at the first communication device, and the model description further comprises attribute information for a model monitoring mode, wherein the processor is configured to cause the first communication device to:
receive, from the second communication device, the model description in model transfer of the AI/ML model, and
wherein the processor is further configured to cause the first communication device to:
perform monitoring of the AI/ML model using the collected ground-truth data based on the model monitoring mode.

9. The device of claim 1, wherein the first communication device is a network device or a location management function (LMF) at which the AI/ML model is deployed for direct positioning or assisted positioning of the terminal device, and wherein the processor is further configured to cause the first communication device to:
transmit, to an access and mobility management function (AMF), a location service request related to the terminal device.

10. A second communication device comprising:
a processor configured to cause the second communication device to:
transmit, to a first communication device, a model trigger condition indication or a model description related to an artificial intelligence/machine learning (AI/ML) model, the model trigger condition indication indicating a trigger condition for triggering the AI/ML model to be applied in direct positioning or assisted positioning of a terminal device, and the model description comprising attribute information for ground-truth collection,
wherein the first communication device is configured for monitoring the AI/ML model, and a target ground-truth collection mode for collecting ground-truth data of the AI/ML model is determined based on the model trigger condition indication or the model description.

11. The device of claim 10, wherein the processor is further configured to cause the second communication device to:
transmit, to a fourth communication device at which the AI/ML model is deployed, the model trigger condition indication or the model description.

12. The device of claim 10, wherein the model trigger condition indication indicates at least one of the following trigger conditions for triggering the AI/ML model:
a first trigger condition related a power saving factor,
a second trigger condition related to a physical environment factor,
a third trigger condition related to a communication network factor, or
a fourth trigger condition related to a positioning latency factor.

13. The device of claim 12, wherein at least one of the first trigger condition, the second trigger condition, the third trigger condition, or the fourth trigger condition comprises a plurality of subcategories of trigger conditions, and
wherein the model trigger condition indication further indicates at least one of the plurality of subcategories of trigger conditions for triggering the AI/ML model to be applied in direct positioning or assisted positioning of the terminal device.

14. The device of claim 10, wherein the model trigger condition indication further indicates enablement or disablement of a ground-truth collection mode based on radio access technology (RAT)-dependent positioning or RAT-independent positioning.

15. The device of claim 10, wherein the AI/ML model is deployed at the first communication device, and wherein the processor is configured to cause the second communication device to:
transmit, to the first communication device, the model trigger condition indication in at least one of the following:
in model transfer of the AI/ML model,
in an activation request to activate the AI/ML model deployed at the first communication device, or
in a monitoring request for the AI/ML model.

16. The device of claim 10, wherein the AI/ML model is deployed at the first communication device, and wherein the processor is configured to cause the second communication device to:
transmit, to the first communication device, the model description in model transfer of the AI/ML model,
wherein a model monitoring mode for the AI/ML model is further inserted in the model description.

17. A communication method comprising:
receiving, by a first communication device and from a second communication device, a model trigger condition indication or a model description related to an artificial intelligence/machine learning (AI/ML) model, the model trigger condition indication indicating a trigger condition for triggering the AI/ML model to be applied in direct positioning or assisted positioning of a terminal device, and the model description comprising attribute information for ground-truth collection;
determining a target ground-truth collection mode for the AI/ML model based on the model trigger condition indication or the model description; and
collecting, based on the target ground-truth collection mode, ground-truth data for monitoring the AI/ML model.

18. A communication method comprising:
transmitting, by a second communication device and to a first communication device, a model trigger condition indication or a model description related to an artificial intelligence/machine learning (AI/ML) model, the model trigger condition indication indicating a trigger condition for triggering the AI/ML model to be applied in direct positioning or assisted positioning of a terminal device, and the model description comprising attribute information for ground-truth collection,
wherein the first communication device is configured for monitoring the AI/ML model, and a target ground-truth collection mode for collecting ground-truth data of the AI/ML model is determined based on the model trigger condition indication or the model description.

19. A computer readable medium having instructions stored thereon, the instructions, when executed on at least one processor, causing the at least one processor to perform the method according to claim 17 or the method according to claim 18.
